(19) United States
(12) Patent Application Publication
(10) Pub. No.: US 2009/0162127 A1
(43) Pub. Date: Jun. 25, 2009

(54) IMAGE RECORDING DEVICE AND ITS CONTROL METHOD

(75) Inventor: Masaaki SHIBUYA, Tokyo (JP)

Correspondence Address: FRISHAUF, HOLTZ, GOODMAN & CHICK, P.C., 16th Floor, 220 Fifth Avenue, New York, NY, 10017-2023, US

(73) Assignee: Olympus Corporation, Tokyo (JP)

(21) Appl. No.: 12/336,729

(22) Filed: Dec. 17, 2008

(30) Foreign Application Priority Data
Dec. 19, 2007 (JP) 2007-327062
Dec. 4, 2008 (JP) 2008-309479

(51) Int. Cl. B41J 11/00

(52) U.S. Cl. 400/621.2

(57) ABSTRACT

This is an image recording device for recording images on a carried recording medium in a continuous sheet and cutting down the recording medium on which images are recorded into pieces of paper of a prescribed size by a cutting unit driven in synchronization with the carrying speed of the recording medium wherein a cutting timing of cutting the recording medium by the cutting unit and a record starting timing of recording the images on the recording medium is controlled using the cutting timing as a starting point.

### CROSS REFERENCE TO RELATED APPLICATIONS

This application claims the benefit of Japan Application No. 2007-327062 filed Dec. 19, 2007, and Japan Application No. 2008-309479 filed Dec. 4, 2008, the contents of which are incorporated by this reference.

### BACKGROUND OF THE INVENTION

1. Field of the Invention

The present invention relates to an image recording device and its control method records an image to a continuous paper and has a mechanism for cutting the continuous paper which was recorded.

2. Description of the Related Art

As one example of an image recording device, for example, there is an ink-jet printer. Ink-jet printer are designed to perform desired recording by ejecting an ink through very small nozzles provided in an ink-jet head, and ejecting the ink to a recording medium. In this case, for the recording medium used to record images, a recording medium (a continuous paper), such as a roll paper or the like is used. An image recording device in which images are recorded in such a continuous paper comprises a post-treatment mechanism for cutting down the continuous image-recorded paper into pieces of paper of a prescribed size.

For example, Patent Document 1 (Japan Patent Application Laid-open No. 2000-318245) proposes a cutting method without using cutting marks, of generating cutting pulses at prescribed intervals on a condition that a continuous paper is carried at stable speed and correcting cutting timing by delay time Tc according to the delay of cutter operation.

### SUMMARY OF THE INVENTION

The image recording device in one aspect of the present invention comprises a carrier unit for carrying a recording medium in a continuous sheet, a carrier information generation unit for generating a signal for indicating the carrying status of the carrier unit, an image recording unit which is controlled on the basis of the signal generated by the carrier information generation unit, for recording images on the recording medium, a cutting unit having cutting blade, which is controlled on the basis of the signal generated by the carrier information generation unit, for cutting down the image-recorded recording medium into pieces of paper of a prescribed size, a detection unit for detecting position of the cutting blade and outputting a detected signal and an image recording control unit for controlling record starting timing for applying the image recording to the recording medium of the image recording unit, wherein the image recording control unit controls the record starting timing on the basis of the detected signal.

The control method of an image recording device in another aspect of the present invention comprises recording images the carried recording medium in a continuous sheet and cutting down the image-recorded recording medium into pieces of paper of a prescribed size by the cutting unit which is driven in synchronization with the carrying speed of the recording medium, wherein detecting cutting timing for cutting the recording medium by the cutting unit and controlling record starting timing for applying the image recording to the recording medium on the basis of the cutting timing.

### BRIEF DESCRIPTION OF THE DRAWINGS

FIG. 1 is the block diagram of the image recording device of this preferred embodiment.

FIG. 2 shows the layout in schematic form of the image recording device excluding the control unit of the preferred embodiment.

FIG. 3 is a block diagram showing the image recording control unit of this preferred embodiment.

FIG. 4 shows the concept on the control of image recording timing in the image recording device in this preferred embodiment.

FIG. 5 shows the record starting timing of the image recording device in this preferred embodiment.

FIG. 6 is a flowchart showing the operating process of the image recording device in this preferred embodiment.

### DESCRIPTION OF THE PREFERRED EMBODIMENT

The image recording device in one preferred embodiment of the present invention is described below with reference to the drawings.

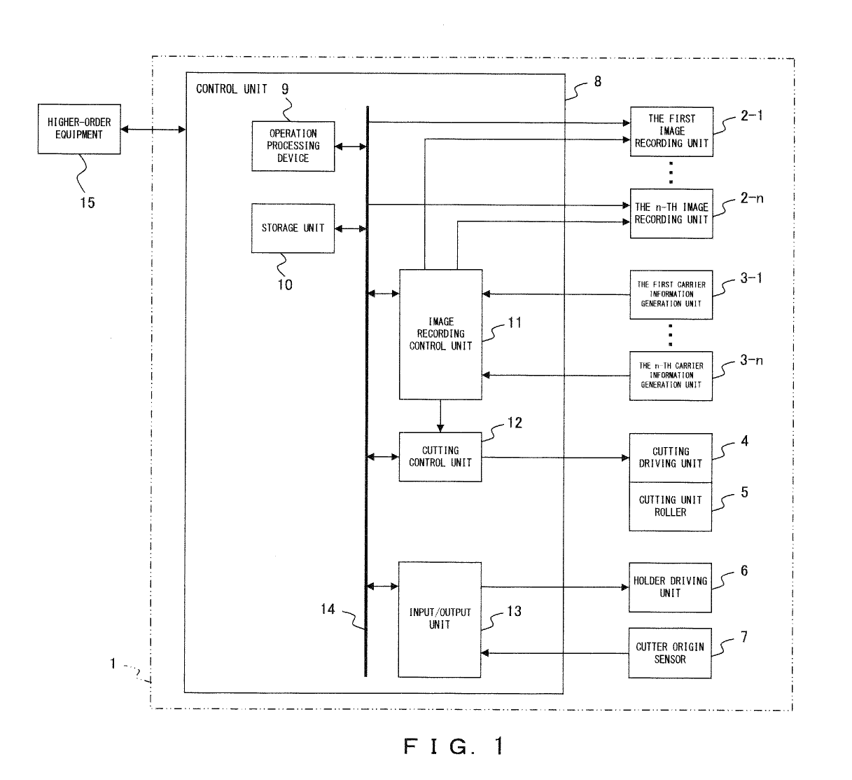

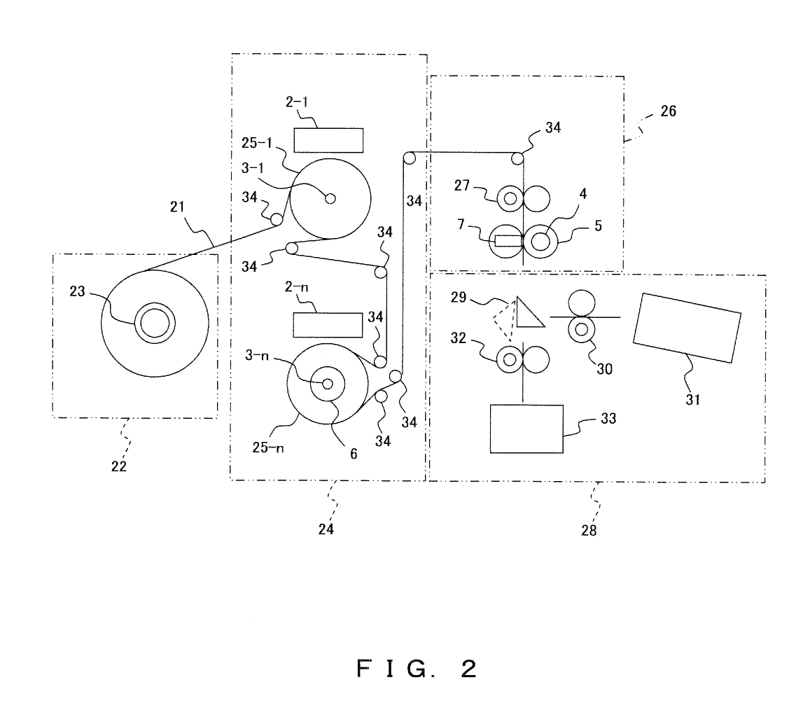

FIG. 1 is the block diagram of the image recording device of this preferred embodiment. FIG. 2 shows the layout in schematic form of the image recording device excluding the control unit of the preferred embodiment.

The image recording device 1 in this preferred embodiment comprises a medium feeding system 22, an image recording system 24, a medium cutting system 26 and an ejection system 28.

Firstly, the medium feeding system 22 is described.

As shown in FIG. 2, the medium feeding system 22 is a rolling out unit which holds a recording medium 21 in a rotatable state and rolls out the recording medium 21 to the image recording system 24. In the medium feeding system 22 of the image recording device 1 in this preferred embodiment, a roll paper is held as a recording medium.

The medium feeding system 22 further comprises a powder clutch 23. The powder clutch 23 gives certain back tension in the direction the reversal of the carrying direction of the recording medium 21.

Next, the image recording system 24 is described.

The image recording system 24 carries the recording medium 21 carried from the medium feeding system 22 by first medium holder 25-1 to n-th medium holder 25-n and free rollers 34, and records images by first image recording unit 2-1 to n-th image recording unit 2-n. Then, it sends out the recorded recording medium 21 to the medium cutting system 26.

As shown in FIG. 2, this image recording system 24 comprises the carrier unit of the recording medium 21 consisting of the first medium holder 25-1 to the n-th medium holder 25-n consisting of a plurality of free rollers 34 and first carrier information generation unit 3-1 to n-th carrier information generation unit 3-n, and an image recording unit consisting of the first image recording unit 2-1 to the n-th image recording unit 2-n disposed opposed to the first medium holder 25-1 to the n-th medium holder 25-n.

The image recording system 24 shown in FIG. 2 is configured in such a way as to record both surfaces of the recording medium 21 by providing two image recording unit. However, the image recording device 1 in this preferred embodiment is not limited to such a configuration. For example, it can also comprises one set of an image recording unit 2 and a medium holder 25 in such a way as to record images a single surface of the recording medium 21. Alternatively, it can also comprise three or more sets of an image recording unit 2 and a medium holder 25. Therefore, n is an integer of 1 or more. In FIG. 2, n=2, and in the following description of FIG. 2, it is assumed that the second image recording unit, the second medium holder and the second carrier information generation unit are 2-n, 25-n and 3-n, respectively, for the sake of a simplified description.

The recording medium 21 rolled out of the medium feeding system 22 is carried to the first medium holder 25-1 via one free roller 34.

Next, the structure of the first medium holder 25-1 is described.

The first medium holder 25-1 of the image recording device in this preferred embodiment is structured as a drum made of aluminum. The recording medium 21 is wound around the first medium holder 25-1 at an angle of 330 deg. and is designed in such a way as to have a circumferential length corresponding to approximately three pieces of paper of a size A3 in the longer side (420 mm).

The recording medium 21 gives vertical reaction to the outer circumferential surface of the first medium holder 25-1 by the winding starting tension and winding ending tension. Then, the recording medium 21 is held on the first medium holder 25-1 by the friction force between the first medium holder 25-1 and the recording medium 21. The first medium holder 25-1 is structured as a driven drum rotated by the second medium holder 25-n via the recording medium 21.

The first carrier information generation unit 3-1 is connected to the rotation shaft of the first medium holder 25-1. The rotation shaft of this first carrier information generation unit 3-1 rotates following to the rotation of the first medium holder 25-1. Thus, the first carrier information generation unit 3-1 outputs a signal (detection pulse) corresponding to the rotating position of the first medium holder 25-1. This detection pulse is inputted to the first image recording unit 2-1 and a cutting control unit 12 via an image record control unit 11 and the like.

A first recording head, which is not shown in FIG. 2, in the first image recording unit 2-1 ejects ink in synchronization with the detection pulse outputted from the first carrier information generation unit 3-1 by a first head driving unit, which is not shown in FIG. 2.

The first carrier information generation unit 3-1 in this preferred embodiment uses a rotary encoder for outputting 18,000 pulse for each rotation of the first medium holder 25-1. The resolution in the carrying direction of the recording medium 21 is 300 dpi (=25.4 μm) and is designed to record one line for each pulse outputted by the first carrier information generation unit 3-1. Thus, the diameter of the first medium holder 25-1 is 485 mm.

After the first medium holder 25-1 is wound up, the recording medium 21 is carried to the second medium holder 25-n via the free roller 34.

Next, the structure of the second medium holder 25-n is described.

The second medium holder 25-n has the same structure as the first medium holder 25-1. The recording medium 21 is wound at the angle of 330 deg. is structured as a drum made of aluminum. The recording medium 21 gives vertical reaction to the outer circumferential surface of the second medium holder 25-n by the winding starting tension and winding ending tension. Then, the recording medium 21 is held on the second medium holder 25-n by the friction force between the second medium holder 25-n and the recording medium 21. In this case, a holder driving unit 6 is connected to the rotation shaft of the second medium holder 25-n. The recording medium 21 is carried by the driving force of this holder driving unit 6. Specifically, the second medium holder 25-n is structured as a driving drum. By structuring the first and second medium holders 25-1 and 25-n as driven and driving drums, respectively, the first and second medium holders 25-1 and 25-n rotates at the same speed.

As in the first medium holder 25-1, the second carrier information generation unit 3-n for outputting a signal (detection pulse) of 18,000 pulse for each rotation of the second medium holder 25-n is connected to the rotation shaft of the second medium holder 25-n.

The second carrier information generation unit 3-n outputs the detection pulse corresponding to the rotating position of the second medium holder 25-n. This detection pulse is inputted to the second image recording unit 2-n and the cutting control unit 12 via the image record control unit 11 and the like. A second recording head, which is not shown in FIG. 2, in the second image recording unit 2-n ejects ink in synchronization with the detection pulse outputted from the second carrier information generation unit 3-n by a second head driving unit, which is not shown in FIG. 2.

After the second medium holder 25-n is wound up, the recording medium 21 is sent to the medium cutting system 26.

Next, the medium cutting system 26 is described.

The medium cutting system 26 comprises a pair of cutter feeding rollers 27, a cutter driving unit 4, a cutting unit roller 5 and cutter origin sensor 7.

The pair of cutter feeding rollers 27 is rotated by a driving source, which is not shown in FIG. 2, and feeds the recording medium 21 sent out from the image recording system 24 to the cutting unit roller 5. The cutting unit roller 5 is driven by the cutter driving unit 4 and cuts down the recording medium 21 fed by the pair of cutter feeding rollers 27 into pieces of paper of a prescribed size. In this case, the length (size) in the carrying direction of the recording medium 21 cut by the cutting unit roller 5 is described as Len_PA. In this preferred embodiment, the cutting unit roller 5 is a spiral-shaped cutter having two pieces of blades and the circumferential length of the roller is 420 mm. The two pieces of blades are disposed at intervals of 210 mm and if the cutting unit roller 5 is driven in synchronization with the carrying speed of the recording medium 21, the recording medium 21 is cut down into pieces of paper having the length of 210 mm. Specifically, Len_PA=210 mm. In this description, it is assumed that the image recording device in this preferred embodiment uses a continuous paper 297 mm wide as the recording medium 21, cuts it into pieces of paper of a size A4 (297 mm*210 mm) and ejects them. Hereinafter, Len_PA=210 mm is called Len_A4Y.

For the cutter driving unit 4, a so-called servo-motor is used, which is driven by giving a pulse-string instruction to the cutting control unit 12 from the image recording control unit 11. The cutter driving unit 4 is not limited to the servo-motor and a stepping motor can also be used.

The cutter origin sensor 7 is a detection unit for detecting the position of the cutter blades of the cutting unit roller 5. The cutter origin sensor 7 in this preferred embodiment is disposed in the cutting position where the recording medium 21 is cut down. Thus, the cutter origin sensor 7 detects whether the cutter blades provided for the cutting unit roller 5 passes over the cutting position. Then, a detected signal of the cutter origin sensor 7 is outputted to an input/output unit 13 and the detected position is reported to the image recording control unit 11 via an operation processing device 9. If the recording medium 21 does not reach the cutting unit roller 5 yet, this cutter origin sensor 7 outputs L to the input/output unit 13. If the recording medium 21 reaches the cutting unit roller 5, this cutter origin sensor 7 outputs H to the input/output unit 13.

Next, the ejection system 28 is described.

The ejection system 28 comprises an ejection route switching unit 29, a pair of rollers 30, a paper ejection table 31, a pair of rollers 32 and a discarded medium recovery box 33.

The ejection route switching unit 29 switches the ejection route of the recording medium 21 cut down by the medium cutting system 26 to the paper ejection table 31 or the discarded medium recovery box 33 according to an instruction from the image recording control unit 11. The ejection route switching unit 29 leads unwanted white paper generated before the start or after the end of the recording process to the discarded medium recovery box 33 and leads the image-recorded recording medium 21 to the ejection table 31.

In order to smoothly eject the cut recording medium 21, the pair of rollers 30 is disposed on the route to the paper ejection table 31 and the pair of rollers 32 are disposed on the route to the discarded medium recovery box 33. These pairs of rollers 30 and 32 are rotated by the driving source, which is not shown in FIG. 2, and lead the cut recording medium fed to the paper ejection table 31 or the discarded medium recovery box 33.

Next, the control unit 8 is described.

The control unit 8 comprises an operation processing device 9, a storage unit 10, an image recording control unit 11, a cutting control unit 12, an input/output unit 13 and a bus 14.

As shown in FIG. 1, the operation processing device 9 is connected to the storage unit 10, the image recording control unit 11, the cutting control unit 12 and the input/output unit 13, in the control unit 8 by the bus 14. The operation processing device 9 is also connected to the first image recording unit 2-1 to the n-th image recording unit 2-n of the image recording system 24 and higher-order equipment 15.

The storage unit 10 temporarily stores the control program of this image recording device, record data from the higher-order equipment 15 and the like. The storage unit 10 also stores various adjustment parameter values and the like, of the image recording device 1. The record data reported from the higher-order equipment 15 includes at least the size information of the recording medium 21 to be cut by the cutting unit roller 5.

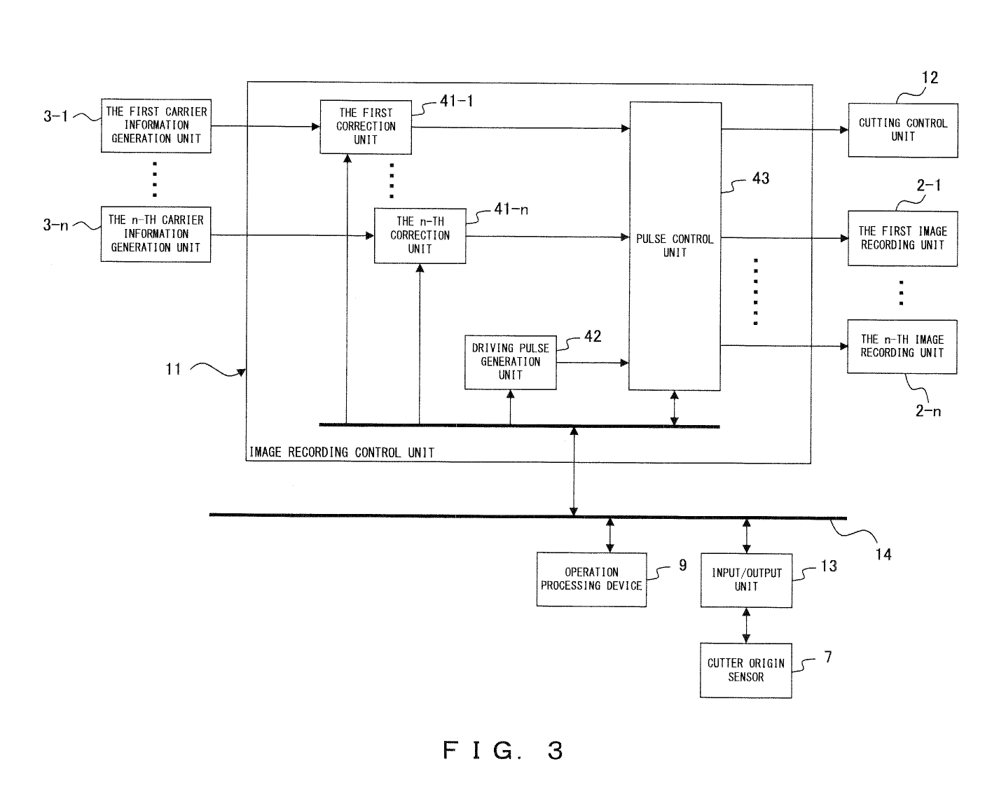

FIG. 3 is the block diagram of the image recording control unit 11.

As shown in FIG. 3, the image recording control unit 11 comprises a first correction unit 41-1 to n-th correction unit 41-n, a driving pulse generation unit 42 and a pulse control unit 43. Like the second medium holder 25-n, hereinafter the n-th correction unit 41-n is called a second correction unit 41-n.

The image recording control unit 11 inputs the signals of the first carrier information generation unit 3-1 to the n-th carrier information generation unit 3-n to the first correction unit 41-1 to the n-th correction unit 41-n, respectively.

As described earlier, the control unit 8 functions as the image recording control unit 11 by enabling, for example, the operation processing device 9 to execute the control program in advance stored in the storage unit 10.

The image recording control unit 11 can be structured by either hardware or the combination of the hardware and software (control program) executed by the operation processing device 9 for controlling the hardware.

Although as described above, the first medium holders 25-1 to the n-th medium holder 25-n are composed drums having the diameter of 485 mm in terms of design, an error and eccentricity are generated in the course of process. Since these error and eccentricity lead to the deterioration of recording accuracy, information for correcting these is in advance stored in the first correction unit 41-1 to the n-th correction unit 41-n for each medium holder as profiles. Then, the first correction unit 41-1 to the n-th correction unit 41-n correct the information of the inputted first carrier information generation unit 3-1 to the n-th carrier information generation unit 3-n on the basis of each profile value. Then, the first correction unit 41-1 to the n-th correction unit 41-n output the corrected pulses to the pulse control unit 43. Since as to this correction technique, there are various proposals and this is not the subject matter of this application, its detailed description is omitted.

The driving pulse generation unit 42 generates an instruction pulse for driving the cutting driving unit 4 when the recording process is not performed and outputs it to the pulse control unit 43.

The pulse control unit 43 selects the pulse from the first correction unit 41-1 to the second correction unit 41-n and the driving pulse generation unit 42 according to a selection instruction from the operation processing device 9 and outputs it to the cutting control unit 12.

More particularly, when recording images, the operation processing device 9 selects the output of the first correction unit 41-1 to the second correction unit 41-n and gives an instruction to the cutting driving unit 4. As a result, the cutting driving unit 4 is driven in synchronization with the carrying amount of the recording medium 21. When operating without carrying the recording medium 21 in the process at the time of jam, when the cutting unit roller 5 restoring to the origin and so on, the operation processing device 9 selects an pulse from the driving pulse generation unit 42 and gives an instruction to the cutting driving unit 4. As a result, the cutting driving unit 4 is driven in asynchronization with the carrying amount of the recording medium 21.

When recording images, the pulse control unit 43 outputs pulses from the first correction unit 41-1 to the second correction unit 41-n to the first image recording unit 2-1 to the second image recording unit 2-n, respectively. The pulse control unit 43 also has a function to count the pulses from the first correction unit 41-1 to the second correction unit 41-n according to an instruction from the operation processing device 9.

Next, the control of the cutting unit roller 5 and the control of record starting timing which are subject matter of this preferred embodiment are described.

Firstly, the control of the cutting unit roller 5 is described.

As described earlier, two pieces of blades are attached to the cutting unit roller 5 at intervals of 210 mm. Then, the cutting unit roller 5 is driven by the cutting driving unit 4 in synchronization with the carrying speed of the recording medium 21 and cuts down the recording medium 21 into pieces of paper having the length of 210 mm. The cutting driving unit 4 is driven by the image recording control unit 11 inputting a pulse string to the cutting control unit 12. This cutting driving unit 4 rotates around a motor shaft once by inputting 8,000 pulses.

In this case, since the rotation speed of the cutting unit roller 5 is synchronized with the carrying speed of the recording medium 21, a speed information of the recording medium 21 must be obtained. Since the pulse of the first carrier information generation unit 3-1 is outputted at 300 dpi (=25.4 μm), this pulse is converted and is applied to the cutting unit roller 5 as a driving pulse.

As described earlier, the circumference is 420 mm, which corresponds to 4,960 (=420/25.4*300) pulses if it is converted to the number of pulses of the first carrier information generation unit 3-1. Therefore, if the cutting control unit 12 is structured in such a way that the cutting unit roller 5 may rotate around the motor shaft once with 4,960 pulses, the cutting unit roller 5 rotates around the motor shaft once while the recording medium 21 is carried by 420 mm and the cutting driving unit 4 is synchronized with the carrying amount of the recording medium 21. Since as described above, the cutting driving unit 4 itself is specified in such a way as to rotate around the motor shaft once with 8,000 pulses. The cutting driving unit 4 converts a frequency using a PLL or the like in such a way as to output 8,000 pulses when 4,960 pulses are inputted under the control of the cutting control unit 12. Since this technique is already known, its detailed description is omitted.

The rotation speed of the recording medium 21 and that of the cutting unit roller 5 are synchronized with each other by the above-described method. If the recording medium 21 is carried, accordingly, the cutting unit roller 5 rotates.

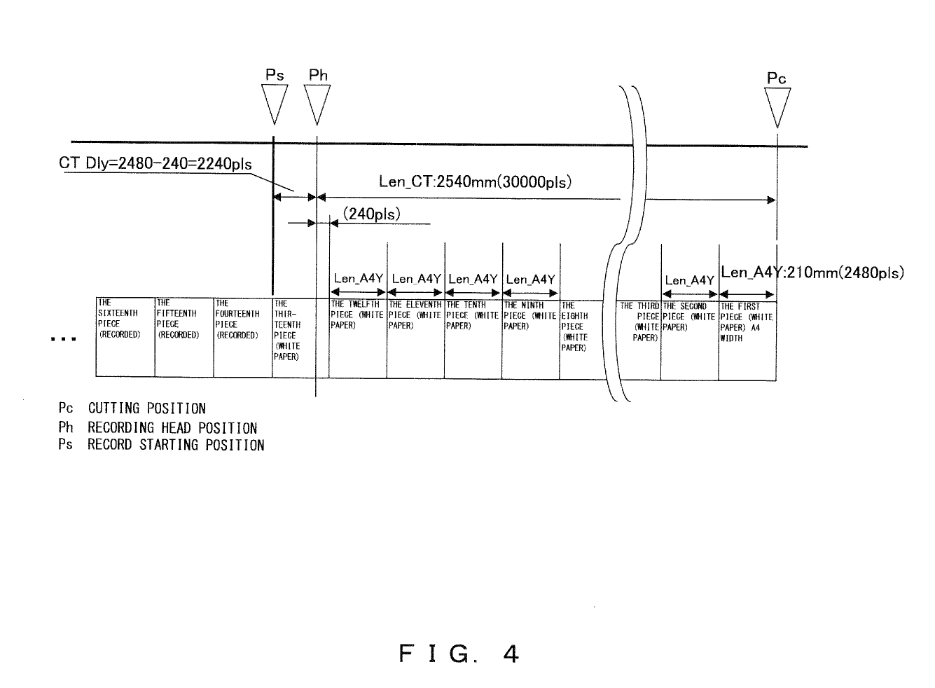

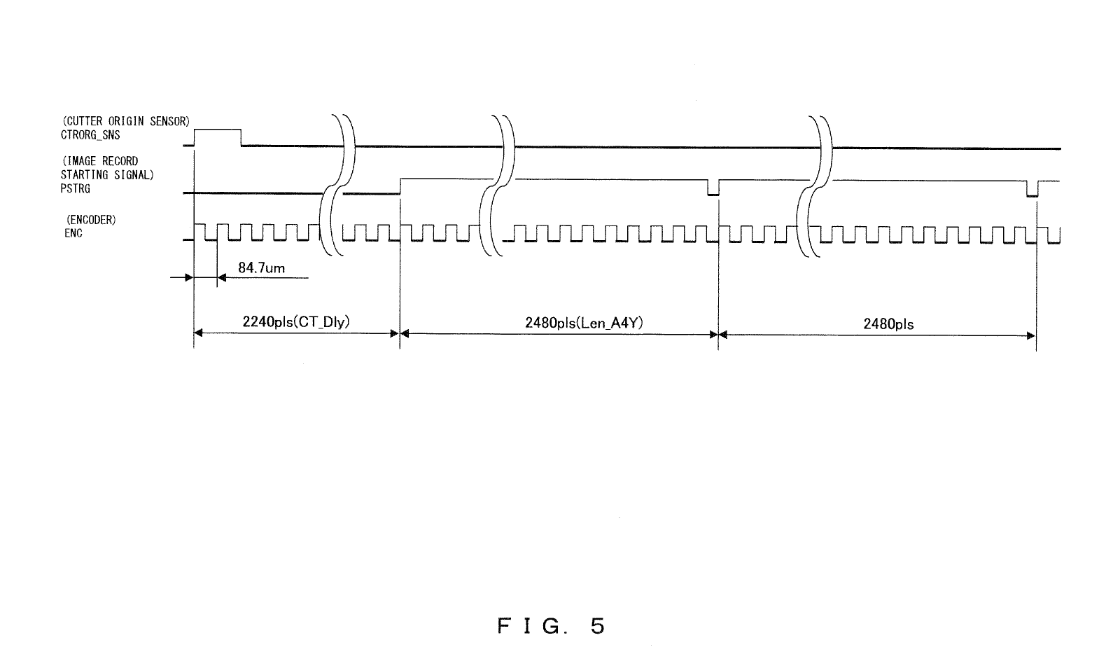

Next, the control of image recording timing is described with reference to FIGS. 4 and 5.

FIG. 4 shows the conceptual position relationship between the first medium holder 25-1 and the cutting position (blade position) of the cutting unit roller 5. FIG. 5 shows the timing between the detection signal of the cutter origin sensor 7 in the first image recording unit and the record starting signal. For the sake of simplification, here only the operation of the first image recording unit 2-1 is described in detail and its detailed relationship with the second image recording unit 2-n is omitted.

In FIG. 4, timings Pc, Ph and Ps are a position where the blades of the cutting unit roller 5 cuts down the recording medium 21, an image recording position in the case where the timing Pc is its reference and an actual image recording position, respectively.

The distance between the recording position of the first image recording unit 2-1 and the blade position of the cutting unit roller 5 is the distance between Pc and Ph in shown in FIG. 4, that is, the distance value shown by Len_CT. This value of Len_CT can be actually measured in the assembly process or the like and peculiar to each piece of equipment. Therefore, the value of Len CT is in advance stored in the storage unit 10. Then, the record starting timing is calculated on the basis of this Len_CT value and the cutting size (Len_PA) of the recording medium 21 cut by the cutting unit roller 5. In this preferred embodiment, it is designed that Len_CT=2,540 mm and Len_PA (Len_A4Y)=210 mm holds true.

In this case, the distance 2,540 mm shown by Len_CT is the pulse of the first carrier information generation unit 3-1 and corresponds to 30,000 pulses (=2,540/25.4*300). Similarly, the A4 short-side length of 210 mm (Len_A4Y) being cutting size corresponds to 2,480 (=210/25.4*300).

Therefore, if the recording of the first image recording unit 2-1 starts when the detection signal H is received from the cutter origin sensor 7, as shown in FIG. 4, the relationship between the recording position of the first image recording unit 2-1 and the cutting position of the cutting unit roller 5 are 12 pieces of A4 size paper and recording starts from a position deviated from the pulse of the first carrier information generation unit 3-1 by 240 pulses (30,000−2480*12). In other words, the first image recording unit 2-1 starts recording from a position 240 pulses ahead from the top end of the thirteenth piece of paper, in which the recording position and the cutting position is not matched.

Therefore, in this case, it is OK if the record starting timing of the first image recording unit 2-1 is delayed in such a way as to coincide with the cutting position of the fourteenth piece of paper counting from when the detection signal H is received from the cutter origin sensor 7. Specifically, it is OK if the recording of the first image recording unit 2-1 is started after the record starting timing of delayed by the distance between timings Ph and Ps. In this case, it is assumed that the amount of delay is CT_Dly.

The amount of delay CT_Dly is 2,240 (=2,480 pulses (A4 short-side cutting size)−240 pulses (amount of advance)). The recording position and the cutting position can be matched by delaying the record starting timing by 2,240 pulses in this way.

This relationship is shown in FIG. 5 as a timing chart.

In FIG. 5, the signal of the cutter origin sensor 7, the record starting signal and the corrected pulse of the first correction unit 41-1 are indicated by CTRORG_SNS, PSTRG and ENC, respectively.

The control unit 8 counts the rising edge of ENC by the pulse control unit 43 after detecting the ON of the cutter origin sensor 7, that is, CTRORG_SNS. Then, it is OK if the control unit 8 makes the record starting signal PSTRG ON in the timing the count value becomes 2,240 pulses shown by the amount of delay CT_Dly to start recording images on the first image recording unit 2-1. Thus, the cutting position of the cutting unit roller 5 and the top end of the first page of the recorded image of the first image recording unit 2-1 can be matched.

For the continuous recording of the second page, the third page and the like after that, it is OK if the control unit 8 outputs the record starting signal PSTRG by the number of pages to record in the cycle of 2480 pulses of the pulse ENC of the cutting size Len_A4Y, that is, the first carrier information generation unit 3-1.

At this moment, although the pulse ENC of the first carrier information generation unit 3-1 must be counted by 2,480 pulses (Len_A4Y), it is OK if the control unit 8 enables the pulse control unit 43 to count it by so many. Thus, the cutting position at every pages and the position at the top end of a recorded image can be matched.

In this case, since as described earlier, the resolution of the image recording device 1 is 300 dpi, as shown in ENC of FIG. 5, a pulse width of the pulse of the first carrier information generation unit 3-1 becomes 84.7 μm (=25.4/300).

In this preferred embodiment, Len_CT is set to 2,540 mm (Len_CT=2,540). However, if this Len_CT value is an integral multiple of the cutting size, it is OK to start recording of the first image recording unit 2-1 when receiving the detection signal H from the cutter origin sensor 7. Specifically, if Len CT=N*Len_PA (N: integer) holds true, the amount of delay CT_Dly becomes 0 pulse. As a result, the recording position and the cutting position can be matched by starting recording of the first image recording unit 2-1 when receiving the detection signal H from the cutter origin sensor 7.

In this way, the operation processing device 9 reads out Len_CT stored in the storage unit 10 and calculates CT_Dly on the basis of Len_CT and Len_PA as described earlier. Alternatively, the amount of delay CT_Dly can be in advance stored in the storage unit 10 according to a cutting size. Thus, there is no need for the operation processing device 9 to calculate the amount of delay CT_Dly for each recording process. In that case, the operation processing device 9 can read out the amount of delay CT_Dly from the storage unit 10 and determine a record starting timing.

By the above-described method, the recording position of the recording medium 21 on the first image recording unit 2-1 and the cutting position of the cutting unit roller 5 can be matched at all pages. By using the pulse of the first carrier information generation unit 3-1, being a recording head ejection synchronous signal, for driving control of the cutting unit roller 5 as described earlier, the accuracy of the cutting position against the recording position can be improved. As to the recording position matching of the second image recording unit 2-n, it is OK to calculate or measure in advance the number of pulses of the first carrier information generation unit 3-1 corresponding to the distance between the first image recording unit 2-1 and the second image recording unit 2-n and to control the control unit 8 in such a way that the record starting timing of the second image recording unit 2-n may delay against the record starting timing of the first image recording unit 2-1 by this number of pulses.

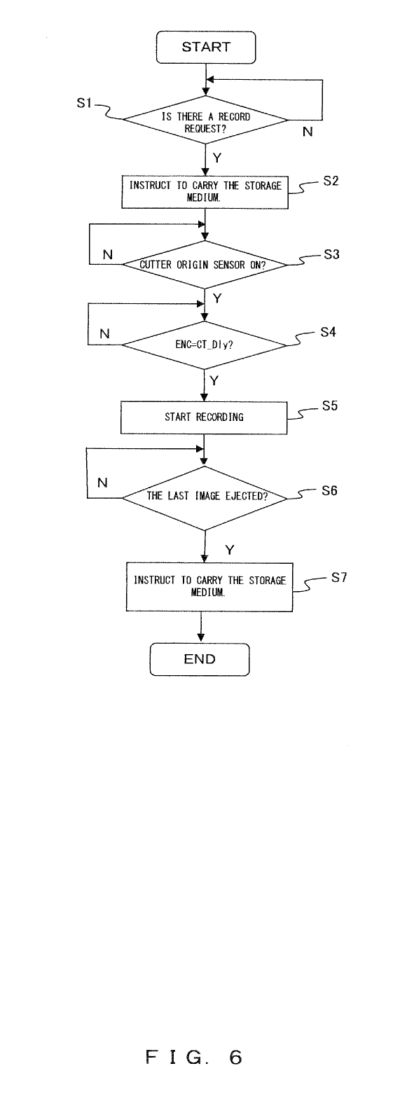

The recording process of the image recording device 1 in this preferred embodiment is described below with reference to FIG. 6.

FIG. 6 is a flowchart showing the operation at the time of recording of the image recording device 1.

The process shown in FIG. 6 is realized by the control unit 8 in the image recording device 1 executing the control program in the storage unit 10.

After the initialization process of the image recording device 1 is completed, in step 1 the control unit 8 of the image recording device 1 waits for a record request from the higher-order equipment 15 (N in step S1).

Upon receipt of the record request from the higher-order equipment 15 (Y in step S1), in step 2 the control unit 8 instructs the holder driving unit 6 to carry the recording medium 21. At this moment, the cutting driving unit 4 is also driven in synchronization with the holder driving unit 6.

Then, in step 3 the control unit 8 waits for the output of the cutter origin sensor 7 (N in step S3). Then, upon receipt of the output of the cutter origin sensor 7 (Y in step S3), in step 4 the control unit 8 counts until the pulse ENC of the first carrier information generation unit 3-1 reaches the amount of delay CT_Dly read out from the storage unit 10. In this case, the amount of delay CT_Dly is calculated as described earlier.

When the count value of this ENC coincides with the CT_Dly (Y in step S4), the control unit 8 instructs the first and second image recording units 2-1 and 2-n to start recording images (step 5). Then, the recorded recording medium 21 is carried downstream.

Then, in step 6 the control unit 8 determines whether the last image is ejected. If the last image is ejected (Y in step S6), in step 7 the image recording control unit 11 instructs the holder driving unit 6 to stop carrying the recording medium 21. At this moment, the image recording control unit 11 also instructs the cutting driving unit 4 to stop. Then, the process is terminated.

As described above, the image recording device 1 in this preferred embodiment can be inexpensively and easily configured without using a so-called cut mark detection unit and the complex control circuit of a cutting mechanism by the control unit 8 controlling the timing of image formation by the signal of the carrier information generation unit 3 and the signal from the cutter origin sensor 7 in the medium cutting system 26, thereby preventing the device through put deterioration due to the detection mistake of the detection unit.

By controlling to link the timing of image formation to the cutting timing of the recording medium 21 of the medium cutting system 26, an image recording device capable of cutting the recording medium 21 without the deterioration of its cutting accuracy can be provided.

According to this preferred embodiment, an image recording device capable of improving its cutting accuracy and avoiding the through put deterioration of recording without using a cut mark detection unit and the complex control circuit of a cutting mechanism and the control method thereof can be realized.

What is claimed is:

1. An image recording device, comprising:
a carrier unit for carrying a recording medium in a continuous sheet;
a carrier information generation unit for generating a signal for indicating a carrying status of the carrier unit;
an image recording unit which is controlled on the basis of the signal generated by the carrier information generation unit, for recording images on the recording medium;
a cutting unit having a cutting blade, which is controlled on the basis of the signal generated by the carrier information generation unit, for cutting down the image-recorded recording medium into pieces of paper of a prescribed size;
a detection unit for detecting position of the cutting blade and outputting a detected signal; and
an image recording control unit for controlling record starting timing for applying the image recording to the recording medium of the image recording unit, wherein
the image recording control unit controls the record starting timing on the basis of the detected signal.

2. The image recording device according to claim 1, wherein
the cutting unit is a rotating body and rotates in synchronization with carrying speed of the recording medium carried by the carrier unit.

3. The image recording device according to claim 2, wherein
the cutting unit cuts down the carried recording medium without stopping the recording medium.

4. The image recording device according to claim 1, wherein
the detection unit detects a cutting position of the cutting blade.

5. The image recording device according to claim 1, wherein
the image recording control unit delays the record starting timing by a prescribed amount using a time the detection unit has outputted the detected signal as a starting point.

6. The image recording device according to claim 5, wherein
the amount of delay is calculated on the basis of a distance between a recording position in the image recording unit and a cutting position in the cutting unit and a length in a carrying direction of the recording medium to be cut down into pieces of paper of the prescribed size by the cutting unit.

7. The image recording device according to claim 6, wherein
if the distance between the recording position in the image recording unit and the cutting position in the cutting unit is Len_CT and the length in the carrying direction of the recording medium to be cut down into pieces of paper of the prescribed size is Len PA,
in the case of Len_CT=n×Len_PA (n: integer of 1 or more), recording is started at the same time the detection unit outputs the detected signal and
in the case of Len_CT=n×Len_PA+α (n: integer 1 or more, 0<α<Len_PA), recording is started being delayed by the signal corresponding to (Len_PA)−(α) in the carrier information generation unit using a time the detection unit outputs the detected signal as a starting point.

8. The image recording device according to claim 1, wherein
if a distance between the recording position in the image recording unit and the cutting position in the cutting unit is Len_CT and a length in the carrying direction of the recording medium to be cut down into pieces of paper of the prescribed size is Len_PA,
in the case of, Len_CT=n×Len_PA (n: integer of 1 or more 1), the image recording control unit starts recording at the same time the detection unit outputs the detected signal, and
in the case of Len_CT=n×Len_PA+α (n: integer of 1 or more, 0<α<Len_PA), the image recording control unit delays recording by the signal corresponding to (Len_PA)−(α) in the carrier information generation unit using a time the detection unit outputs the detected signal as a starting point.

9. An image recording device, comprising:
carrier means for carrying a recording medium in a continuous sheet;
carrier information generation means for generating a signal for indicating the carrying status of the carrier means;
image recording means which is controlled on the basis of the signal generated by the carrier information generation means, for recording images on the recording medium;
cutting means having a cutting blade, which is controlled on the basis of the signal generated by the carrier information generation means, for cutting down the image-recorded recording medium into pieces of paper of a prescribed size; and
detection means for detecting a position of the cutting blade, wherein
a record starting timing of recording images on the recording medium of the image recording means is controlled on the basis of a detection signal of the detection means.

10. A control method of an image recording device for recording images on a carried recording medium in a continuous sheet and cutting down the recording medium on which images are recorded into pieces of paper of a prescribed size by a cutting unit driven in synchronization with carrying speed of the recording medium, comprising:
detecting cutting timing for cutting the recording medium by the cutting unit and controlling record starting timing for applying the image recording to the recording medium on the basis of the cutting timing.

11. The control method of an image recording device according to claim 10, wherein
the record starting timing is delayed by a prescribed amount using a time that the cutting timing is detected as a starting point.

12. The control method of an image recording device according to claim 11, wherein
the amount of delay is calculated on the basis of a distance between a recording position where the images are recorded and a cutting position where the recording medium is cut down and length in a carrying direction of the recording medium to be cut down into pieces of paper of the prescribed size.

13. The control method of an image recording device according to claim 12, wherein
if the distance between the recording position in the image recording unit and the cutting position in the cutting unit is Len_CT and
the length in the carrying direction of the recording medium to be cut down into pieces of paper of the prescribed size is Len_PA,
in the case of Len_CT=n×Len_PA (n: integer of 1 or more), recording is started at the same time the cutting timing is detected and
in the case of Len_CT=n×Len_PA+α (n: integer of 1 or more, 0<α<Len_PA), recording is started being delayed by the signal corresponding to (Len PA)−(α) using a time that the cutting timing is detected as a starting point.

14. The control method of an image recording device according to claim 10, wherein
if a distance between the recording position in the image recording unit and the cutting position in the cutting unit is Len_CT and
a length in the carrying direction of the recording medium to be cut down into pieces of paper of the prescribed size is Len_PA,
in the case of Len_CT=n×Len_PA (n: integer of 1 or more), the record starting timing starts at the same time the cutting timing is detected and
in the case of Len_CT=n×Len_PA+α (n: integer of 1 or more, 0<α<Len_PA), the record starting timing starts being delayed by the signal corresponding to (Len_PA)−(α) using a time that the cutting timing is detected as a starting point.
